(19) United States
(12) Patent Application Publication
(10) Pub. No.: US 2009/0061145 A1
(43) Pub. Date: Mar. 5, 2009

(54) DUAL-INJECTION MOLDING ARTICLE AND METHOD FOR MAKING SAME

(75) Inventor: TSUNG-PENG LIN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/964,812

(22) Filed: Dec. 27, 2007

(30) Foreign Application Priority Data
Aug. 30, 2007 (CN) 200710201535.5

(51) Int. Cl. B29C 45/13

(52) U.S. Cl. 428/67; 264/250

(57) ABSTRACT

A dual-injection molding article (10) includes a first molding portion (20), a second molding portion (30) and a groove (40). The first molding portion has a hole (213) defined therein, and an inside surface (214) surrounding the hole. The second molding portion includes a base plate (31) and a protruding portion (33). The base plate is integrally formed on the first molding portion. The protruding portion is inserted inside the hole. The groove is defined between a peripheral sidewall of the protruding portion and the inside surface of the first molding portion. A method for making the dual-injection molding member is also provided.

### BACKGROUND

1. Technical Field

The present invention relates to injection molding articles and, particularly to a dual-injection molding article and a method for making same.

2. Description of the Related Art

Many kinds of workpieces, such as injection molding articles are fabricated by means of injection molding. Typically, dual-injection molding articles are used to create a plastic part made of two different materials or two different colors of the same material.

A typical dual-injection molding article 90, as shown in FIG. 7, includes a first portion 92 and a second portion 95 made of different material from that of the first portion 92. In molding, a first material for fabricating the first portion 92 is injected into a first space of a mold to form the first portion 92. After the first material of the first portion 92 solidifies, the second material for making the second portion 95 is injected into the mold. After the second material solidifies, materials forming the first and second portions 92, 95 adhere with each other and form a mechanical bond therebetween. Thus, a whole molding article 90 is formed.

However, if the second material has a higher melting point than that of the first material, when the melted second material is injected into the mold, there's a risk that the first portion 92, which is molded in the mold previously, may be melted and mixed by the second material due to its high temperature. Therefore, the joint/connection area of the first portion 92 and the second portion 95 may become distorting and ambiguous, as shown in FIG. 7, which accordingly decreases the aesthetic visibility of the molding article 90.

Therefore, an improved dual-injection molding article and method for making same is desired in order to overcome the above-described problems.

### SUMMARY

In one aspect, a dual-injection molding article is provided. The dual-injection molding article includes a first molding portion, a second molding portion, and a groove. The first molding portion has a hole defined therein, and an inside surface surrounding the hole. The second molding portion includes a base plate and a protruding portion. The base plate is integrally formed on the first molding portion. The protruding portion is integrally formed on the base plate, and is received in the hole. The groove is defined between a peripheral sidewall of the protruding portion and the inside surface of the first molding portion.

In another aspect, a method for making the dual-injection molding member is provided. The method includes the following steps: providing a mold; injecting a first material into the mold to form a first molding portion having a hole defined therein and an inside surface surrounding the hole; placing a block member inside the hole of the first molding portion, and the blocking member having an opening defined therein; and injecting a second material into the mold to form a second molding portion having a base plate integrally formed on the first molding portion, and a protruding portion integrally formed on base plate and being received inside the opening.

Other advantages and novel features will become more apparent from the following detailed description when taken in conjunction with the accompanying drawings.

### BRIEF DESCRIPTION OF THE DRAWINGS

Many aspects of the present dual-injection molding article and method for making same can be better understood with reference to the following drawings. The components in the drawings are not necessarily drawn to scale, the emphasis instead being placed upon clearly illustrating the principles of the dual-injection molding article and method for making same. Moreover, in the drawings, like reference numerals designate corresponding parts throughout the several views.

FIG. 1 is a schematic, isometric view of a dual-injection molding article, in accordance with a present embodiment.

FIG. 2 is a disassembled view of the molding articles of FIG. 1.

FIG. 3 is similar to FIG. 1, but viewed form another aspect.

FIG. 4 shows a disassembled view of the molding article of FIG. 3.

FIG. 5 shows a step of making the molding article, wherein a blocking member is intended to be placed inside a first molding portion of the molding article.

FIG. 6 shows another step of making the molding article, wherein a blocking member has been placed inside a first molding portion of the molding article.

FIG. 7 shows a schematic, isometric view of a typical dual-injection molding article.

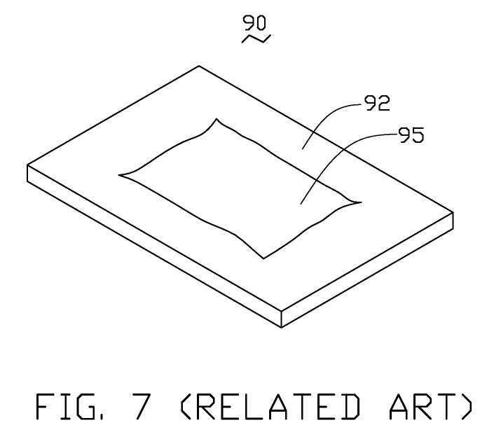

### DETAILED DESCRIPTION OF THE PREFERRED EMBODIMENT

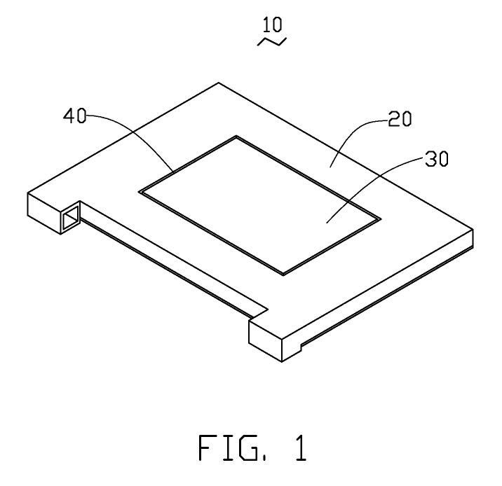

The present dual-injection molding article is suitable for portable electronic devices such as mobile phones, personal digital assistants (PDAs) and so on. Referring now to the drawings in detail, FIG. 1 shows a dual-injection molding article 10 used as a front panel of a mobile phone, according to a present embodiment. The molding article 10 includes a first molding portion 20, and a second molding portion 30. The second molding portion 30 is integrally formed on the first molding portion 20 via a dual-injection molding process. In the present embodiment, the first molding portion 20 is made of polycarbonate (PC) material, which is black and opaque. The second molding portion 30 is made of polymethyl methacrylate (PMMA) material, which is transparent.

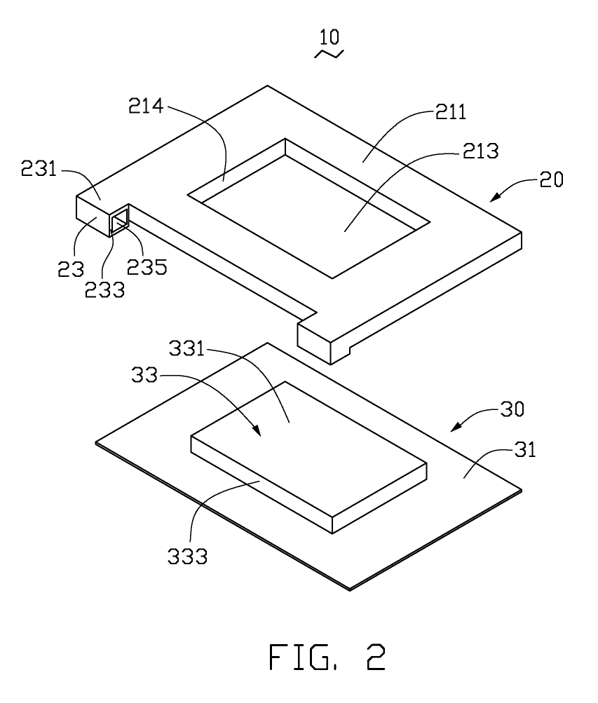

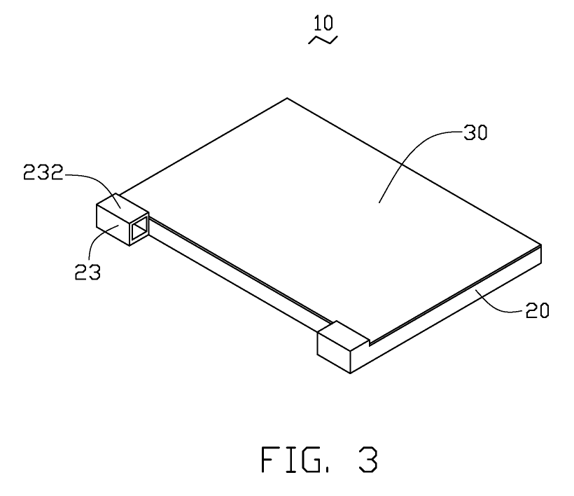

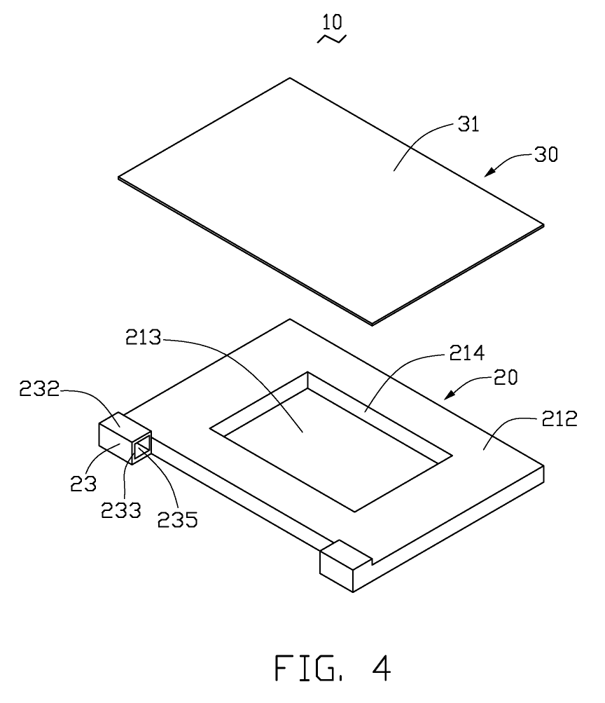

Also referring to, FIGS. 2-4, the first molding portion 20 is substantially a rectangular frame in shape, and includes a frame section 21 and an engaging section (not labeled) integrally formed on the frame section 21. The frame section 21 has a top surface 211, a bottom surface 212, and a hole 213 defined therein. The top surface 211 and the bottom surface 212 are positioned opposite to each other. The hole 213 penetrates through the surfaces 211, 212 thereby forming an inside surface 214 surrounding the hole 213. The engaging section includes a pair of engaging protrusions 23 protruding outwardly from the frame section 20 and disposed at two opposite end of an outside surface of the frame section 21. Each engaging protrusion is approximately a rectangular block in shape, and has a top side 231, a bottom side 232, and an inner side 233. The top sides 231 of the engaging protrusions 23 are flushed with the top surface 211 of the frame section 21. The bottom sides 232 of the engaging protrusions 23 protrude from the bottom surface 212 of the frame section 21. The inner sides 233 each has an engaging recess 235 defined therein, and are configured for mating with other engaging structures of the portable electronic device.

The second molding portion 30 includes a base plate 31, and a protruding portion 33 integrally formed on an upper surface of the base plate 31. The base plate 31 has an outer perimeter equal to that of the frame section 21. The protruding portion 33 has an upper side 331 positioned opposite to the upper surface of base plate 31, and a peripheral sidewall 333 protruding from the upper surface of the base plate 31. The peripheral sidewall 333 has a peripheral dimension smaller than that of the inside surface 214 of the frame section 21. The height of the protruding portion 33 is approximately equal to that of the frame section 21.

The upper surface of the base plate 31 is integrally formed on the bottom surface 212 of frame section 21. The protruding portion 33 is inserted into the hole 213 of the frame section 21 with the supper side 331 is flushed with the top surface 211 of the frame section 21. A groove 40 is thereby formed between the peripheral sidewall 333 of the protruding portion 33 and the inside surface 214 of the frame section 21. The protruding portion 33 can act as a display screen, since it is made of transparent material.

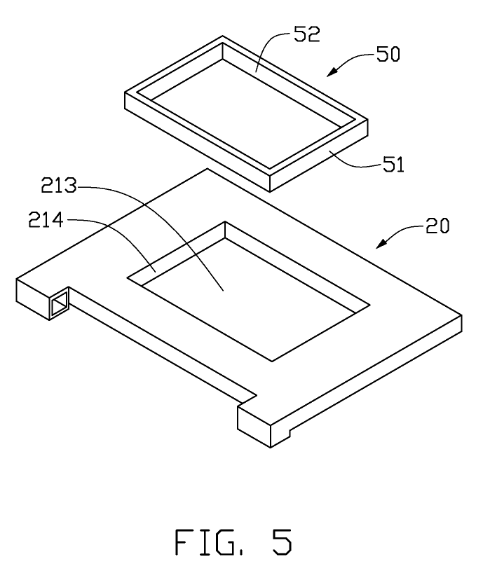

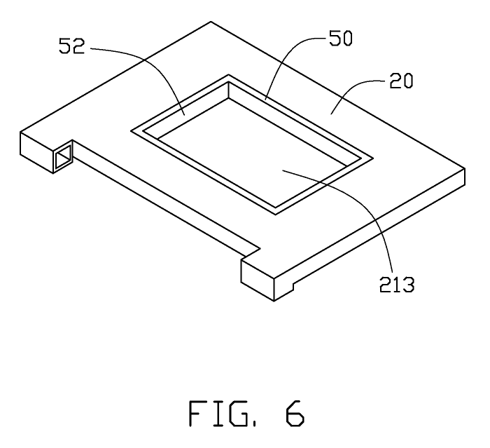

Referring to FIGS. 5 and 6, a method for making the dual-injection molding article 10 includes the following steps:

providing a mold;

injecting the PC material (a first material) to form a first molding portion 20;

placing a block member 50 with an opening 53 defined therein inside a hole 213 of the first molding portion 20;

injecting the PMMA material (a second material) to form a second molding portion 30 having a base plate 31 connecting to the first mold portion 20 and a protruding portion 33 received in the opening 53 of the first mold portion 20;

cooling; and

removing the block member 50 from the molding article 10.

The block member 50 is a frame member in shape, and includes an outer side 51, an inner side 52, and an opening 53 defined therein. The outer side 51 of the block member 50 has a profile similar to the inside surface 214 of the frame section 21 with a dimension approximately equal to that of the inside surface 214 of the frame section 21. The inner side 53 of the block member 50 has a profile similar to that of the outer sidewall 333 of the protruding portion 33 with a dimension approximately equal to that of the peripheral sidewall 333 of the protruding portion 33. In the molding process, the block member 50 is sandwiched between the inside surface 214 of the frame section 21 and the peripheral sidewall 333 of the protruding portion 33, and thus prevents the first material and the second material from blending/mixing/pervasion with each other. After the block member 50 is removed, the groove 40 is defined between the inside surface 214 of the frame section 21 and the peripheral sidewall 333 of the protruding portion 33. The boundaries of the first and second molding portions 20, 30 are clear, and the aesthetic visibility of the molding article 10 will not be affected.

It is to be understood that the block member 50 can be placed in the mold before the step of injecting the first material.

It is further to be understood that the block member 50 can be made of decorating material and used as decorating member of the molding article 10. Thus, the step of removing the block member 50 can be omitted, and the bar member 50 can remain in the molding article 10 to increase aesthetic visibility of the molding article 10.

It is to be understood, however, that even though numerous characteristics and advantages of the present invention have been set forth in the foregoing description, together with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. A dual-injection molding article, comprising:
a first molding portion, having a hole defined therein and an inside surface surrounding the hole; and
a second molding portion comprising:
a base plate integrally formed on the first molding portion;
a protruding portion integrally formed on base plate and being received inside the hole; and
a groove defined between a peripheral sidewall of the protruding portion and the inside surface of the first molding portion.

2. The dual-injection molding article as claimed in claim 1, wherein a block member is received in the groove, and is integrally formed with the first molding portion and the second molding portion.

3. The dual-injection molding article as claimed in claim 2, wherein the first molding portion is made of polycarbonate material, and the second molding portion is made of polymethyl methacrylate material.

4. The dual-injection molding article as claimed in claim 1, wherein the first molding portion comprises a frame section in which the hole is defined, and an engaging section integrally formed on the frame section.

5. The dual-injection molding article as claimed in claim 4, wherein the frame section has a top surface and an opposite bottom surface, and the engage section has a top side flushed with the top surface, a bottom side protruding from the bottom surface, and an inner side having a recess defined therein.

6. The dual-injection molding article as claimed in claim 5, wherein the base plate is integrally formed on the bottom surface of the frame section, and the protruding portion has an upper side flushed with the top surface of the frame section.

7. A method for making a dual-injection molding member, comprising the following steps:
providing a mold;
injecting a first material into the mold to form a first molding portion having a hole defined therein and an inside surface surrounding the hole;
placing a block member inside the hole of the first molding portion, and the blocking member having an opening defined therein; and
injecting a second material into the mold to form a second molding portion having a base plate integrally formed on the first molding portion, and a protruding portion integrally formed on base plate and being received inside the opening.

8. The method as claimed in claim 7 further comprising a step of removing the block member.

9. A method for making the dual-injection molding member of claim 1, comprising the following steps:
providing a mold having a block member, and the block member having an opening defined therein;
injecting a first material into the mold to form the first molding portion with the block member surrounded by the inside surface of the first molding portion;
injecting a second material in to the mold to form the second molding portion with the base plate integrally formed on the first molding portion, and the protruding portion integrally formed on base plate and being received inside the opening; and
removing the bar member.
